(19) United States
(12) Patent Application Publication
(10) Pub. No.: US 2023/0361964 A1
(43) Pub. Date: Nov. 9, 2023

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/026,193

(22) PCT Filed: Sep. 14, 2020
(86) PCT No.: PCT/CN2020/115157

§ 371 Date: Mar. 14, 2023

(51) Int. Cl. H04L 5/00; H04W 72/232

(52) U.S. Cl. CPC H04L 5/0051; H04W 72/232

(57) ABSTRACT

Embodiments of the present disclosure relate to methods, devices and computer readable media for communication of a RS. According to embodiments of the present disclosure, the terminal device receives information indicating a set of resources for transmitting a reference signal from the network device. If the terminal device receives an indication in a reference signal trigger slot for triggering a transmission of the reference signal, the terminal device determines a slot for transmitting the reference signal. The terminal device determines whether the slot is valid based on a slot configuration. In this way, it can avoid the SRS transmission timing ambiguous or misalignment between UE and network.

### TECHNICAL FIELD

Embodiments of the present disclosure generally relate to the field of telecommunication, and in particular, to methods, devices and computer storage media for communication of a reference signal (RS).

### BACKGROUND

In recent study on a new radio (NR) technology, it is agreed that enhancements on aperiodic RS triggering are critical to facilitate more flexible triggering and downlink control information (DCI) overhead or usage reduction. In this event, it has been proposed to allow dynamic RS triggering slot offset indication. However, no detailed solution on how to find valid slots has been proposed.

### SUMMARY

In general, embodiments of the present disclosure provide methods, devices and computer storage media for communication of a RS.

In a first aspect, there is provided a method of communication. The method comprises: receiving an indication in a reference signal (RS) triggering slot for triggering a transmission of the reference signal; and transmitting the reference signal on a slot based on an indicated timing and one of valid slots, wherein the valid slots comprising all symbols in a set of resources are flexible or uplink.

In a second aspect, there is provided a method of communication. The method comprises: transmitting at a network device and to a terminal device an indication in a reference signal (RS) triggering slot for triggering a transmission of the reference signal; and receiving the reference signal on a slot based on an indicated timing and one of valid slots, wherein the valid slots comprising all symbols in a set of resources are flexible or uplink.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a schematic diagram of slot format according to embodiments of the present disclosure;

FIGS. 3A and 3B illustrate schematic diagrams illustrating processes for communication of a RS according to embodiments of the present disclosure;

FIG. 4 illustrates an example method of communication implemented at a terminal device in accordance with some embodiments of the present disclosure;

FIG. 5 illustrates an example method of communication implemented at a network device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ highest,“minimum,”maximum,' or the like. It will be appreciated that such descriptions are intended to indicate that a selection among many used functional alternatives can be made, and such selections need not be better, smaller, higher, or otherwise preferable to other selections.

In current RS design in NR, a slot offset for aperiodic RS triggering is semi-statically configured by a higher layer parameter. For codebook, non-codebook or antenna-switching based transmissions, only one aperiodic RS resource set for each of these transmissions is supported, and thus only one slot offset is allowed for each of these transmissions. The slot offset may refer to an offset in number of slots between the triggering downlink control information (DCI) and an actual transmission of the reference signal. For example, the slot offset may be any suitable integer number, for example, 0, 1, 2, . . . , 32. Only for purpose of illustrations, embodiments of the present disclosure are described with the reference to sounding reference signal (SRS). It should be noted that embodiments of the present disclosure can be applied to other suitable types of reference signal.

According to some conventional technologies, the following parameters are semi-statically configurable by higher layer parameters: slot level periodicity and slot level offset as defined by the higher layer parameters periodicityAndOffset-p or periodicityAndOffset-sp for an SRS resource of type periodic or semi-persistent, which is configured by SRS-Resource, and periodicityAndOffset-p-r16 or periodicityAndOffset-sp-r16 for an SRS resource of type periodic or semi-persistent, which is configured by SRS-PosResource-r16. The UE is not expected to be configured with SRS resources in the same SRS resource set SRS-ResourceSet or SRS-PosResourceSet-r16 with different slot level periodicities. For an SRS-ResourceSet configured with higher layer parameter resource Type set to aperiodic, a slot level offset is defined by the higher layer parameter slotOffset. For an SRS-PosResourceSet-r16 configured with higher layer parameter resourceType-r16 set to ‘aperiodic’, the slot level offset is defined by the higher layer parameter slotOffset-r16 for each SRS resource.

Further, if a UE is provided tdd-UL-DL-ConfigurationCommon, the UE sets the slot format per slot over a number of slots as indicated by tdd-UL-DL-ConfigurationCommon. The tdd-UL-DL-ConfigurationCommon provides at least one of: a reference SCS configuration μ_{ref} by referenceSubcarrierSpacing and a pattern1. The pattern1 provides at least one of: a slot configuration period of P msec by dl-UL-TransmissionPeriodicity, a number of slots dₛₗₒₜₛ with only downlink symbols by nrofDownlinkSlots, a number of downlink symbols d_{sym} by nrofDownlinkSymbols, a number of slots μₛₗₒₜₛ with only uplink symbols by nrofUplinkSlots and a number of uplink symbols μ_{sym} by nrofUplinkSymbols. A slot configuration period of P may include S=P·2^{μ}^{_{ref}} slots with SCS configuration μ_{ref}. From the S slots, a RS triggering slot dₛₗₒₜₛ may include only downlink symbols and a last slot μₛₗₒₜₛ may include only uplink symbols. The d_{sym} symbols after the RS triggering slot dₛₗₒₜₛ are downlink symbols. The μ_{sym} symbols before the last slots are uplink symbols. The remaining (S-dₛₗₒₜₛ-μₛₗₒₜₛ)·N_{symb}^{slot}-d_{sym}-μ_{sym} are flexible symbols. The first symbol every 20/P periods is a first symbol in an even frame.

If tdd-UL-DL-ConfigurationCommon provides both pattern1 and pattern2, the UE sets the slot format per slot over a first number of slots as indicated by pattern1 and the UE sets the slot format per slot over a second number of slots as indicated by pattern2. The pattern2 provides at least one of: a slot configuration period of P₂ msec by dl-UL-TransmissionPeriodicity, a number of slots d_{slots,2} with only downlink symbols by nrofDownlinkSlots, a number of downlink symbols d_{sym,2} by nrofDownlinkSymbols, a number of slots μ_{slots,2} with only uplink symbols by nrofUplinkSlots and a number of uplink symbols μ_{sym,2} by nrofUplinkSymbols.

A slot configuration period of P+P₂ msec includes first S=P·2^{μ}^{_{ref}} slots and second S₂=P₂·2^{μ}^{_{ref}} slots. From the S₂ slots, a first d_{slots,2} slots include only downlink symbols and a last μ_{sym,2} include only uplink symbols. The d_{sym,2} symbols after the first d_{slots,2} slots are downlink symbols. The μ_{sym,2} symbols before the last μ_{slots,2} slots are uplink symbols. The remaining (S₂d_{slots,2}-μ_{slots,2})·N_{symb}^{slot}-d_{sym,2}-μ_{sym,2} are flexible symbols. A UE expects that P+P₂ divides 20 msec. The first symbol every 20/(P+P₂) periods is a first symbol in an even frame.

If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon. A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are common to each configured bandwidth part (BWP).

If a UE is not configured to monitor physical downlink control channel (PDCCH) for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE may receive physical downlink shared channel (PDSCH) or channel state information reference signal (CSI-RS) in the set of symbols of the slot if the UE receives a corresponding indication by a DCI format. The UE may transmit physical uplink shared channel (PUSCH), physical uplink control channel (PUCCH), physical random access channel (PRACH), or SRS in the set of symbols of the slot if the UE receives a corresponding indication by a DCI format or a random access response (RAR) uplink (UL) grant. DCI format 2_0 may be used for notifying the slot format, channel occupancy time (COT) duration, available resource block (RB) set, and search space group switching.

For a set of symbols of a slot, a UE does not expect to detect a DCI format 2_0 with an SFI-index field value indicating the set of symbols of the slot as uplink and to detect a DCI format 1_0, a DCI format 1_1, or DCI format 0_1 indicating to the UE to receive PDSCH or CSI-RS in the set of symbols of the slot.

For a set of symbols of a slot, a UE does not expect to detect a DCI format 2_0 with an SFI-index field value indicating the set of symbols in the slot as downlink and to detect a DCI format 0_0, DCI format 0_1, DCI format 1_0, DCI format 1_1, DCI format 2_3, a RAR UL grant, fallbackRAR UL grant, or successRAR indicating to the UE to transmit PUSCH, PUCCH, PRACH, or SRS in the set of symbols of the slot.

For a set of symbols of a slot that are indicated as downlink/uplink by tdd-UL-DL-ConfigurationCommon, or tdd-UL-DL-ConfigurationDedicated, the UE does not expect to detect a DCI format 2_0 with an SFI-index field value indicating the set of symbols of the slot as uplink/downlink, respectively, or as flexible.

However, to delay the SRS to another available slot (or re-definition of the triggering offset), there is no details on how to find the available slot. Based on the slot configuration on different timing, valid/available or not for a given slot may be different, it will cause the SRS transmission timing ambiguous or misalignment between UE and network. If valid/available slot definition is based on the final downlink/uplink and flexible symbols, i.e. considering dynamic scheduling and/or DCI format 2-0, there may be misalignment on the timing/slot for SRS transmission/reception between network and UE if the scheduling and/or DCI format 2-0 is missed or not decoded successfully.

In this disclosure, the terms “valid”, “available”, “effective”, “actual”, “real”, “practicable”, “feasible” and “usable” may be used interchangeably.

According to embodiments of the present disclosure, the terminal device receives information indicating a set of resources for transmitting a reference signal from the network device. For example, if the terminal device receives an indication in a RS triggering slot for triggering a transmission of the reference signal, the terminal device determines a slot for transmitting the reference signal. The terminal device determines whether the slot is valid based on a slot configuration. For another example, if the terminal device receives an indication in a RS triggering slot for triggering a transmission of the reference signal, the terminal device determines a valid slot for transmitting the reference signal. In this way, it can avoid the SRS transmission timing ambiguous or misalignment between UE and network.

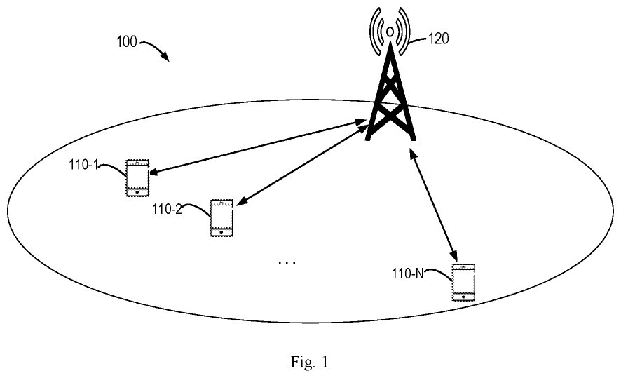

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises network terminal device 120-1, a network device 120-2, . . . , a network device 120-M, which can be collectively referred to as “network device(s) 120.” In some embodiments, the network device may be gNB. Alternatively, the network device may be IAB. The number M can be any suitable integer number. In the communication system 100, the network devices 120 and the terminal devices 110 can communicate data and control information to each other. Only for the purpose of illustrations, the network device 120-1 can be regarded as a source network device and the network device 120-2 can be regarded as a target network device. The numbers of terminal devices and network devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

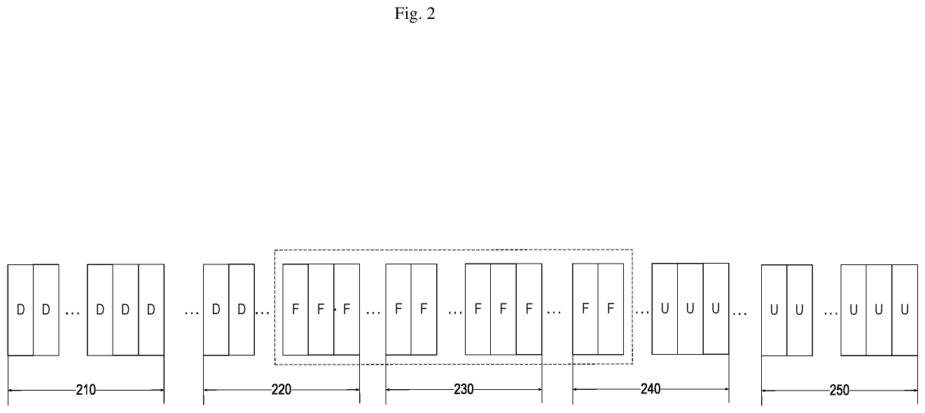

FIG. 2 illustrates a schematic diagram of slot format according to embodiments of the present disclosure. By way of example, as shown in FIG. 2, there may be five slots, 210, 220, 230, 240 and 250. The symbols in the slot 210 may be used for downlink transmission and the symbols in the slot 250 may be used for uplink transmission. A subset of symbols in the slot 220 may be used for downlink transmission and the remaining symbols may be flexible, which means it can be scheduled for downlink or uplink. A subset of symbols in the slot 240 may be used for uplink transmission and the remaining symbols may be flexible, which means it can be scheduled for downlink or uplink. The symbols in the slot 230 may be flexible, which means it can be scheduled for downlink or uplink. Since the flexible symbols may be scheduled, it needs to find available slot.

Embodiments of the present disclosure will be described in detail below.

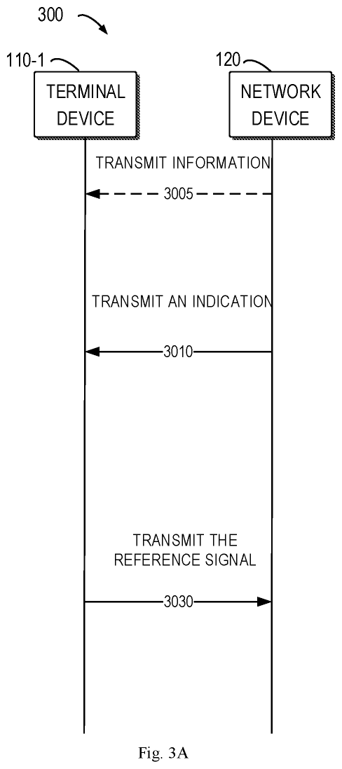

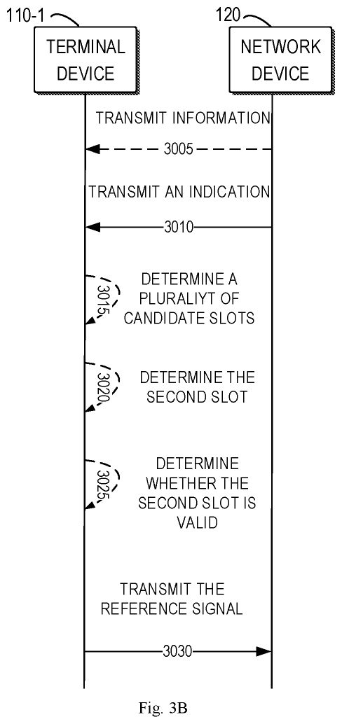

Reference is first made to FIGS. 3A and 3B, which shows a signaling chart illustrating process 300 among network devices according to some example embodiments of the present disclosure. Only for the purpose of discussion, the process 300 will be described with reference to FIG. 1. The process 300 may involve the terminal device 110-1 and the network device 120 in FIG. 1.

In some embodiments, the network device 120 may transmit (e.g. shown as 3005 in FIGS. 3A and 3B) information to the terminal device 110-1. The information indicates a set of resources for transmitting a reference signal. In some embodiments, the RS may be a downlink RS. For example, the RS may be any one or more of a demodulation reference signal (DMRS), a cell reference signal (CRS), a multicast broadcast single frequency network (MBSFN) reference signal, a positioning reference signal (PRS), a fine time/frequency tracking reference signal (TRS), a phase tracking reference signal (PTRS), a channel state information-reference signal (CSI-RS), a CSI-RS for tracking and a CSI-RS for mobility. In some alternative embodiments, the RS may be an uplink RS. For example, the RS may be any one or more of a sounding reference signal (SRS), a demodulation reference signal (DMRS), a positioning reference signal (PRS), a fine time/frequency tracking reference signal (TRS) and a phase tracking reference signal (PTRS). It should be noted that the RS may be any downlink or uplink reference signal existing in the art or to be developed in the future.

In some embodiments, the information may comprise a slot offset value of the set of resources. In some embodiments where multiple resource sets are configured, the information may comprise a set of slot offset values (also referred to as a first set of slot offset values below) for the multiple resource sets. For example, the values of slot offset in the set are different to each other. In some embodiments, the first set of slot offset values may comprise a slot offset value for each of the multiple resource sets. In some embodiments, the number of slot offset values in the first set of slot offset values may be smaller than the number of the multiple resource sets. In some embodiments, the network device 110 may configure the first information to the terminal device 120 in a radio resource control (RRC) message. It should be note that the first information may be transmitted in any other suitable ways, for example, in a media access control (MAC) control element (CE) or downlink control information (DCI), and the present disclosure does not make limitation for this.

In some embodiments, the network device and the terminal device may communicate with each other based on time slots (or slots for short) as defined in the 3GPP specifications. For example, for subcarrier spacing configuration μ, slots are numbered nₛ^{μ}ϵ {0, . . . , Nₛₗₒₜ^{subframe,μ}−1} in an increasing order within a subframe and n_{s,f}^{μ}ϵ {0, . . . , Nₛₗₒₜ^{subframe,μ}−1 } in an increasing order within a frame. There are N_{symb}^{slot} consecutive Orthogonal Frequency Division Multiplexing (OFDM) symbols in a slot where N_{symb}^{slot} depends on the cyclic prefix as given in related 3GPP specifications (TS 38.211), as shown in Table 1 and Table 2. The start of slot nₛ^{μ} in a subframe is aligned in time with the start of OFDM symbol Nₛ^{μ}N_{symb}^{slot} in the same subframe. Other related definitions and information of slots can be found in existing or future 3GPP specifications. More generally, the term slot as used herein can refer to any existing defined unit of time or any unit of time to be defined in the future.

TABLE 1
Number of OFDM symbols per slot, slots per frame,
and slots per subframe for normal cyclic prefix.

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 2
Number of OFDM symbols per slot, slots per frame,
and slots per subframe for extended cyclic prefix.

| μ | N_{symb}^{slot} | Nₛₗₒₜ^{frame, μ} | Nₛₗₒₜ^{subframe, μ} |
|---|---|---|---|
| 2 | 12 | 40 | 4 |

In some embodiments, the network device 120 may transmit (e.g. shown as 3010 in FIGS. 3A and 3B) an indication to the terminal device 110-1 in a RS triggering slot. The indication is to trigger transmitting the reference signal. In some embodiments, the indication may be transmitted or received at slot n. In some embodiments, n is non-negative integer. For example, the value of “n” may be from 0 to 150. For example, the indication may be transmitted in DCI and/or MAC CE. In some embodiments, the network device 120 may configure a slot offset k to the terminal device 110. In some embodiments, k is non-negative integer. For example, the value of “k” may be from 0 to 32. Alternatively, the value of “k” may be from 0 to 64.

In some embodiments, the terminal device 110-1 may determine (e.g. shown as 3015 in FIG. 3B) a plurality of candidate slots for aperiodic SRS transmission. For example, if the indication is received at the slot n and the slot offset is k, the plurality of candidate slots may comprise one or more of: the slot n+k, the first valid slot after slot n+k, the second valid slot after slot n+k, the L^{th} available slot after slot n+k, the k^{th} available slot, the (k+l)^{th} available slot or the (k+i)^{th} available slot, where the parameter “i” may be any suitable positive integer and the parameter “L” may be any suitable positive integer. In some embodiments, the terminal device 110-1 may determine a slot for aperiodic SRS transmission. For example, if the indication is received at the slot n and the slot offset is configured as k, the slot for aperiodic SRS transmission may be any one of: the slot n+k, the first valid slot after slot n+k, the second valid slot after slot n+k, the L^{th} available slot after slot n+k, the k^{th} available slot, the (k+l)^{th} available slot or the (k+i)^{th} available slot, where the parameter “i” may be any suitable positive integer and the parameter “L” may be any suitable positive integer. In some embodiments, i is non-negative integer. For example, the value of “i” may be from 0 to 10. Alternatively, the value of “i” may be from 0 to 32. In some embodiments, L is non-negative integer. For example, the value of “L” may be from 0 to 32. Alternatively, the value of “L” may be from 0 to 10. In some embodiments, the value of L may be predetermined. In some embodiments, the value of L may be configured by the network device 120 via at least one of RRC signaling, MAC CE and DCI. In some embodiments, the value of L may be different for different value of k. For example, for a value k1 of k, the value of L is L1. And for a value k2 of k, the value of L is L2. And if k1>k2, then L1 should be not smaller than L2. The number of candidate slots can be any suitable number. In some embodiments, the number of candidate slots may be predetermined. Alternatively or in addition, the number of the candidate slots may be configured by the network device 120 via at least one of RRC signaling, MAC CE and DCI. For example, the number of the candidate slots may be configured by RRC signaling. Alternatively, the MAC CE may be used to configure the number of the candidate slots. In another embodiment, the DCI may indicate the number of the candidate slots.

In some embodiments, a resource or a candidate slot may be regarded as available or valid if there are available uplink symbol(s) and/or flexible symbol(s) for the configured time-domain location(s) in the resource or in the slot for all the RS resources in the resource set and/or if the resource or the slot satisfies the minimum timing requirement between the triggering indication and all the RS resources in the resource set. For example, for a slot, if any one of the symbols for all the SRS resource(s) in the SRS resource set is flexible and/or uplink, the slot may be regarded as valid or counted in the offset. In some embodiments, for a slot, if at least one of the symbols for all the SRS resource(s) in the SRS resource set is downlink and/or flexible, the slot may regarded as invalid or not valid or not counted in the offset.

In some embodiments, the terminal device 110-1 determines (e.g. shown as 3020 in FIG. 3B) a slot for transmitting the reference signal based on an indicated timing and one of valid slots. The valid slots comprise all symbols in a set of resources are flexible or uplink. For example, if the slot offset is k and the RS triggering slot is slot n, the terminal device 110-1 may determine the slot for transmitting which is the k^{th} flexible and/or uplink slot after the slot n. In some embodiments, the slot for transmitting may be at least one of the slot n+k, the first valid slot after slot n+k, the second valid slot after slot n+k, the L^{th} available slot after slot n+k, the k^{th} available slot, the (k+l)^{th} available slot or the (k+i)^{th} available slot. In some embodiments, the number of slots between the RS triggering slot and the slot for transmitting may be within a predetermined range. For example, if the indication is received at the slot n (i.e., the RS triggering slot may be represented as slot n), the slot for transmitting may be no later than the slot n+M, wherein M is any positive integer number. Alternatively, the slot for transmitting may be earlier than the slot n+M. For example, M may be any number from 1 to 64. Alternatively, M may be any number from 1 to 32. In some embodiments, the value of M may be predetermined. Alternatively or in addition, the value of M may be configured by the network device 120 via at least one of RRC signaling, MAC CE and DCI. For example, the value of M may be configured by RRC signaling. Alternatively, the MAC CE may be used to configure the value of M. In another embodiment, the DCI may indicate the value of M. In some embodiments, if the slot for transmitting is later than the slot n+M, the terminal device may not transmit the configured/triggered RS.

In some embodiments, the terminal device 110-1 may determine a slot (referred to as “a seventh slot” hereinafter) based on the RS triggering slot and a slot offset. In some embodiments, the slot for transmitting may be determined based on the seventh slot and a second predetermined number of slots. The number of slots between the slot for transmitting and the seventh slot may be below or smaller than or no larger than the second predetermined number. The second predetermined number may be any suitable integer. For example, if the indication is received at the slot n (i.e., the RS triggering slot may be represented as slot n), the interval between the slot for transmitting and the slot n+k (i.e., the seventh slot) may be less than or no larger than X slots, where X may be a non-negative integer. For example, the X may be from 0 to 32. For another example, the X may be from 0 to 10. In some embodiments, if the interval between the slot for transmitting and the slot n+k (i.e., the seventh slot) is larger than or equal to X slots, the terminal device may not transmit the configured/triggered RS.

In other embodiments, the RS triggering slot, the slot for transmitting and the seventh slot may be in a same slot period. For example, the slot period may be P. For another example, the slot period may be P+P₂. For another example, the slot period may be one frame. For another example, the slot period may be 20 msec, and the first symbol in the 20 msec is the first symbol in an even frame. In some embodiments, if the slot for transmitting and the slot n+k (i.e., the seventh slot) are in different slot period, the terminal device may not transmit the configured/triggered RS. For example, in this way, the SRS transmission offset may not be changed too much.

In some embodiments, the terminal device 110-1 may obtain a first number of slots and a second number of slots. The first number of slots and the second number of slots may be predetermined. Alternatively, the first number of slots and the second number of slots may be configured by the network device 120 via at least one of RRC, MAC CE and DCI. The terminal device 110-1 may determine a slot after the second number of slots starting from the RS triggering slot plus the first number of slots to be the slot for transmitting. For example, the sum of the first number of slots and the second number of slots may match a slot offset indicated in the information. In some embodiments, if the indication is received in slot n, the slot for transmitting may be the p^{th} or (p+1)^{th} valid slot starting from slot n+q. The values of p and q may be any suitable non-negative integer number. For example, the value of “p” may be from 0 to k. Alternatively, the value of “q” may be from 0 to k. For example, the sum of p and q may be the slot offset k. For another example, the sum of p and q may be k+1. For another example, the sum of p and q may be k−1. In some embodiments, the value of p and/or the value of q may be different based on different values of the slot offset k. In some embodiments, the value of p and/or the value of q may be predetermined. In some embodiments, the value of p and/or the value of q may be configured by the network device via at least one of RRC, MAC CE and DCI. In some embodiments, p may be floor (k/2) and q may be [k-floor(k/2)]. For example, in this way, the SRS transmission offset may not be changed too much.

In other embodiments, the terminal device 110-1 may obtain a third number of slots and a fourth number of slots. The third number of slots and the fourth number of slots may be predetermined. Alternatively, the third number of slots and the fourth number of slots may be configured by the network device 120 via at least one of RRC, MAC CE and DCI. For example, if the indication is received in slot n and the slot offset is k, the slot for transmitting may be (Y+1+n mod Z)^{th} available slot or (Y+n mod Z)^{th} available slot. The value of Y may be the value of slot offset k. Alternatively, the value of Y may be the value of p. Alternatively, the value of Y may be the value of q. In some embodiments, the value of Z may be predetermined. In some embodiments, the value of Z may be configured by the network device via at least one of RRC, MAC CE and DCI. In some embodiments, the value of Z can be any positive integer number. For example, the value of Z may be from 2 to 10. For example, in this way, the congestion for SRS transmission can be avoided.

In some embodiments, the terminal device 110-1 may select (e.g. shown as 3020 in FIG. 3B) the slot for transmitting from the plurality of candidate slots. For example, the slot for transmitting may be determined based on priorities of the plurality of candidate slots. In some embodiments, as mentioned above, the terminal device 110-1 may determine (e.g. 3015) a plurality of candidate slots for aperiodic SRS transmission. For example, if the indication is received at the slot n and the slot offset is k, the plurality of candidate slots may comprise one or more of: the slot n+k, the first valid slot after slot n+k, the second valid slot after slot n+k, the L^{th} available slot after slot n+k, the k^{th} available slot, the (k+l)^{th} available slot or the (k+i)^{th} available slot, where the parameter “i” may be any suitable positive integer and the parameter “L” may be any suitable positive integer. In some embodiments, i is non-negative integer. For example, the value of “i” may be from 0 to 10. Alternatively, the value of “i” may be from 0 to 32. In some embodiments, L is non-negative integer. For example, the value of “L” may be from 0 to 32. Alternatively, the value of “L” may be from 0 to 10. Only as an example, the priority of the slot n+k is higher than the priority of the k^{th} available slot. For another example, the priority of the k^{th} available slot is higher than the (k+1)^{th} available slot. For example, if the slot n+k is valid, the terminal device 110-1 may select the slot n+k to be the slot for transmitting. If the slot n+k is not valid, the terminal device 110-1 may select the first valid slot after slot n+k or the second valid slot after slot n+k or the L^{th} available slot after slot n+k or the k^{th} available slot, the (k+l)^{th} available slot or the (k+i)^{th} available slot to be the slot for transmitting.

In some embodiments, the terminal device 110-1 determines (e.g. shown as 3025 in FIG. 3B) whether the slot for transmitting is valid based on a slot configuration. In some embodiments, the terminal device 110-1 may determine whether the slot for transmitting is valid based on the slot configuration related to the RS triggering slot. In other words, if the indication is received in the slot n, the slot for transmitting may be determined to be valid or not based on the slot configuration related to the slot n. In some embodiments, the terminal device 110-1 may determine whether a slot (for example, a slot starting from slot n or a slot no earlier than slot n or a slot starting from slot n+k or a slot no earlier than slot n+k) is valid or not based on the latest slot configuration which is configured or determined or defined no later than slot n. In some embodiments, the terminal device 110-1 may determine a slot (for example, a slot starting from slot n or a slot no earlier than slot n or a slot starting from slot n+k or a slot no earlier than slot n+k) is valid or not based on the slot configuration which is configured or determined or defined in slot n. In some embodiments, the terminal device 110-1 may determine the (valid) slot for transmitting based on the latest slot configuration which is configured or determined or defined no later than slot n. In some embodiments, the terminal device 110-1 may determine the (valid) slot for transmitting based on the slot configuration which is configured or determined or defined in slot n.

In some embodiments, 3015, 3020 and 3025 are optional in the process 300. In some embodiments, the order of 3015, 3020 and 3025 in the process 300 can be changed. In some embodiments, 3015, 3020 and 3025 in the process 300 can be processed at the same time.

Alternatively, the terminal device 110-1 may determine whether the slot for transmitting is valid based on the slot configuration related to the RS triggering slot and a slot offset. For example, if the indication is received in the slot n and the slot offset is k, the slot for transmitting may be determined to be valid based on the slot configuration defined in the slot n+k. In some embodiments, the terminal device 110-1 may determine whether a slot (for example, a slot starting from slot n or a slot no earlier than slot n or a slot starting from slot n+k or a slot no earlier than slot n+k) is valid or not based on the latest slot configuration which is configured or determined or defined no later than slot n+k. In some embodiments, the terminal device 110-1 may determine a slot (for example, a slot starting from slot n or a slot no earlier than slot n or a slot starting from slot n+k or a slot no earlier than slot n+k) is valid or not based on the slot configuration which is configured or determined or defined in slot n+k. In some embodiments, the terminal device 110-1 may determine the (valid) slot for transmitting based on the latest slot configuration which is configured or determined or defined no later than slot n+k. In some embodiments, the terminal device 110-1 may determine the (valid) slot for transmitting based on the slot configuration which is configured or determined or defined in slot n+k.

In some embodiments, for the slot(s) starting from slot n to slot n+k or the slot(s) which are no earlier than slot n and no later than slot n+k or the slot(s) which are no earlier than slot n and earlier than slot n+k, the terminal device 110-1 may determine whether the slot(s) is valid or not based on the latest slot configuration which is configured or determined or defined no later than slot n. In some embodiments, for the slot(s) starting from slot n to slot n+k or the slot(s) which are no earlier than slot n and no later than slot n+k or the slot(s) which are no earlier than slot n and earlier than slot n+k, the terminal device 110-1 may determine whether the slot(s) is valid or not based on the latest slot configuration which is configured or determined or defined in slot n. In some embodiments, for the slot(s) starting from slot n+k or the slot(s) which are no earlier than slot n+k or the slot(s) which are later than slot n+k, the terminal device 110-1 may determine whether the slot(s) is valid or not based on the latest slot configuration which is configured or determined or defined no later than slot n+k. In some embodiments, for the slot(s) starting from slot n+k or the slot(s) which are no earlier than slot n+k or the slot(s) which are later than slot n+k, the terminal device 110-1 may determine whether the slot(s) is valid or not based on the latest slot configuration which is configured or determined or defined in slot n+k.

In other embodiments, the terminal device 110-1 may determine whether the slot for transmitting is valid based on the slot configuration related to a third slot. The third slot may satisfy a timing requirement between the last symbol for transmitting the indication and the first symbol of a resource for transmitting the reference signal in the set of resources. For example, the third slot may be a RS triggering slot satisfying the minimum timing requirement between triggering PDCCH and all the SRS resources in the resource set. For example, the minimal time interval between the last symbol of the PDCCH triggering the aperiodic SRS transmission and the first symbol of SRS resource is X symbols (for example, X=N2+14+Tswitch or X=N2+Tswitch), whether the slot is valid or not is based on the slot configuration related to the slot n+ceil(X/14) or the slot min(n+k, n+ceil(x/14)). In some embodiments, the terminal device 110-1 may determine whether a slot (for example, a slot starting from slot n or a slot no earlier than slot n or a slot starting from slot n+k or a slot no earlier than slot n+k or a slot no earlier than the third slot or a slot starting from the third slot or a slot later than the third slot) is valid or not based on the latest slot configuration which is configured or determined or defined no later than the third slot. In some embodiments, the terminal device 110-1 may determine a slot (for example, a slot starting from slot n or a slot no earlier than slot n or a slot starting from slot n+k or a slot no earlier than slot n+k or a slot no earlier than the third slot or a slot starting from the third slot or a slot later than the third slot) is valid or not based on the slot configuration which is configured or determined or defined in the third slot. In some embodiments, the terminal device 110-1 may determine the (valid) slot for transmitting based on the latest slot configuration which is configured or determined or defined no later than the third slot. In some embodiments, the terminal device 110-1 may determine the (valid) slot for transmitting based on the slot configuration which is configured or determined or defined in the third slot.

In some embodiments, for the slot(s) starting from slot n to the third slot or the slot(s) which are no earlier than slot n and no later than the third slot or the slot(s) which are no earlier than slot n and earlier than the third slot, the terminal device 110-1 may determine whether the slot(s) is valid or not based on the latest slot configuration which is configured or determined or defined no later than slot n. In some embodiments, for the slot(s) starting from slot n to the third slot or the slot(s) which are no earlier than slot n and no later than the third slot or the slot(s) which are no earlier than slot n and earlier than the third slot, the terminal device 110-1 may determine whether the slot(s) is valid or not based on the latest slot configuration which is configured or determined or defined in slot n. In some embodiments, for the slot(s) starting from the third slot or the slot(s) which are no earlier than the third slot or the slot(s) which are later than the third slot, the terminal device 110-1 may determine whether the slot(s) is valid or not based on the latest slot configuration which is configured or determined or defined no later than the third slot. In some embodiments, for the slot(s) starting from the third slot or the slot(s) which are no earlier than the third slot or the slot(s) which are later than the third slot, the terminal device 110-1 may determine whether the slot(s) is valid or not based on the latest slot configuration which is configured or determined or defined in the third slot.

In some embodiments, the network device 120 may transmit further information indicating a fourth slot. The further information may be transmitted via RRC signaling. Alternatively, the further information may be transmitted in MAC CE. In other embodiments, the further information may be transmitted in DCI. The terminal device 110-1 may determine whether the slot for transmitting is valid based on the slot configuration related to the fourth slot. In some embodiments, the terminal device 110-1 may determine whether a slot (for example, a slot starting from slot n or a slot no earlier than slot n or a slot starting from slot n+k or a slot no earlier than slot n+k or a slot no earlier than the fourth slot or a slot starting from the fourth slot or a slot later than the fourth slot) is valid or not based on the latest slot configuration which is configured or determined or defined no later than the fourth slot. In some embodiments, the terminal device 110-1 may determine a slot (for example, a slot starting from slot n or a slot no earlier than slot n or a slot starting from slot n+k or a slot no earlier than slot n+k or a slot no earlier than the fourth slot or a slot starting from the fourth slot or a slot later than the fourth slot) is valid or not based on the slot configuration which is configured or determined or defined in the fourth slot. In some embodiments, the terminal device 110-1 may determine the (valid) slot for transmitting based on the latest slot configuration which is configured or determined or defined no later than the fourth slot. In some embodiments, the terminal device 110-1 may determine the (valid) slot for transmitting based on the slot configuration which is configured or determined or defined in the fourth slot.

In some embodiments, for the slot(s) starting from slot n to the fourth slot or the slot(s) which are no earlier than slot n and no later than the fourth slot or the slot(s) which are no earlier than slot n and earlier than the fourth slot, the terminal device 110-1 may determine whether the slot(s) is valid or not based on the latest slot configuration which is configured or determined or defined no later than slot n. In some embodiments, for the slot(s) starting from slot n to the fourth slot or the slot(s) which are no earlier than slot n and no later than the fourth slot or the slot(s) which are no earlier than slot n and earlier than the fourth slot, the terminal device 110-1 may determine whether the slot(s) is valid or not based on the latest slot configuration which is configured or determined or defined in slot n. In some embodiments, for the slot(s) starting from the fourth slot or the slot(s) which are no earlier than the fourth slot or the slot(s) which are later than the fourth slot, the terminal device 110-1 may determine whether the slot(s) is valid or not based on the latest slot configuration which is configured or determined or defined no later than the fourth slot. In some embodiments, for the slot(s) starting from the fourth slot or the slot(s) which are no earlier than the fourth slot or the slot(s) which are later than the fourth slot, the terminal device 110-1 may determine whether the slot(s) is valid or not based on the latest slot configuration which is configured or determined or defined in the fourth slot.

In a yet embodiment, the terminal device 110-1 may determine whether the slot for transmitting is valid based on the slot configuration related to a fifth slot which is a slot prior to the RS triggering slot. For example, the fifth slot may be the latest slot with detected DCI format 2-0 which is earlier or no later than the RS triggering slot (i.e., the slot n). In some embodiments, the terminal device 110-1 may determine whether a slot (for example, a slot starting from slot n or a slot no earlier than slot n or a slot starting from slot n+k or a slot no earlier than slot n+k or a slot no earlier than the fifth slot or a slot starting from the fifth slot or a slot later than the fifth slot) is valid or not based on the latest slot configuration which is configured or determined or defined no later than the fifth slot. In some embodiments, the terminal device 110-1 may determine a slot (for example, a slot starting from slot n or a slot no earlier than slot n or a slot starting from slot n+k or a slot no earlier than slot n+k or a slot no earlier than the fifth slot or a slot starting from the fifth slot or a slot later than the fifth slot) is valid or not based on the slot configuration which is configured or determined or defined in the fifth slot. In some embodiments, the terminal device 110-1 may determine the (valid) slot for transmitting based on the latest slot configuration which is configured or determined or defined no later than the fifth slot. In some embodiments, the terminal device 110-1 may determine the (valid) slot for transmitting based on the slot configuration which is configured or determined or defined in the fifth slot.

In some embodiments, for the slot(s) starting from slot n to the fifth slot or the slot(s) which are no earlier than slot n and no later than the fifth slot or the slot(s) which are no earlier than slot n and earlier than the fifth slot, the terminal device 110-1 may determine whether the slot(s) is valid or not based on the latest slot configuration which is configured or determined or defined no later than slot n. In some embodiments, for the slot(s) starting from slot n to the fifth slot or the slot(s) which are no earlier than slot n and no later than the fifth slot or the slot(s) which are no earlier than slot n and earlier than the fifth slot, the terminal device 110-1 may determine whether the slot(s) is valid or not based on the latest slot configuration which is configured or determined or defined in slot n. In some embodiments, for the slot(s) starting from the fifth slot or the slot(s) which are no earlier than the fifth slot or the slot(s) which are later than the fifth slot, the terminal device 110-1 may determine whether the slot(s) is valid or not based on the latest slot configuration which is configured or determined or defined no later than the fifth slot. In some embodiments, for the slot(s) starting from the fifth slot or the slot(s) which are no earlier than the fifth slot or the slot(s) which are later than the fifth slot, the terminal device 110-1 may determine whether the slot(s) is valid or not based on the latest slot configuration which is configured or determined or defined in the fifth slot.

In other embodiments, the terminal device 110-1 may determine whether the slot for transmitting is valid based on the slot configuration related to a sixth slot which is a starting slot of a slot period prior to the RS triggering slot. For example, the sixth slot may be the starting slot of the latest slot format periodicity which is earlier or no later than the RS triggering slot (i.e., the slot n). In some embodiments, the terminal device 110-1 may determine whether a slot (for example, a slot starting from slot n or a slot no earlier than slot n or a slot starting from slot n+k or a slot no earlier than slot n+k or a slot no earlier than the sixth slot or a slot starting from the sixth slot or a slot later than the sixth slot) is valid or not based on the latest slot configuration which is configured or determined or defined no later than the sixth slot. In some embodiments, the terminal device 110-1 may determine a slot (for example, a slot starting from slot n or a slot no earlier than slot n or a slot starting from slot n+k or a slot no earlier than slot n+k or a slot no earlier than the sixth slot or a slot starting from the sixth slot or a slot later than the sixth slot) is valid or not based on the slot configuration which is configured or determined or defined in the sixth slot. In some embodiments, the terminal device 110-1 may determine the (valid) slot for transmitting based on the latest slot configuration which is configured or determined or defined no later than the sixth slot. In some embodiments, the terminal device 110-1 may determine the (valid) slot for transmitting based on the slot configuration which is configured or determined or defined in the sixth slot.

In some embodiments, for the slot(s) starting from slot n to the sixth slot or the slot(s) which are no earlier than slot n and no later than the sixth slot or the slot(s) which are no earlier than slot n and earlier than the sixth slot, the terminal device 110-1 may determine whether the slot(s) is valid or not based on the latest slot configuration which is configured or determined or defined no later than slot n. In some embodiments, for the slot(s) starting from slot n to the sixth slot or the slot(s) which are no earlier than slot n and no later than the sixth slot or the slot(s) which are no earlier than slot n and earlier than the sixth slot, the terminal device 110-1 may determine whether the slot(s) is valid or not based on the latest slot configuration which is configured or determined or defined in slot n. In some embodiments, for the slot(s) starting from the sixth slot or the slot(s) which are no earlier than the sixth slot or the slot(s) which are later than the sixth slot, the terminal device 110-1 may determine whether the slot(s) is valid or not based on the latest slot configuration which is configured or determined or defined no later than the sixth slot. In some embodiments, for the slot(s) starting from the sixth slot or the slot(s) which are no earlier than the sixth slot or the slot(s) which are later than the sixth slot, the terminal device 110-1 may determine whether the slot(s) is valid or not based on the latest slot configuration which is configured or determined or defined in the sixth slot.

In some embodiments, the terminal device 110-1 may determine whether the slot for transmitting is valid only based on the slot configuration. For example, the terminal device 110-1 may determine whether the slot for transmitting is valid based on the RRC configured slot configuration tdd-UL-DL-ConfigurationCommon and/or tdd-UL-DL-ConfigDedicated. For example, regardless of dynamic scheduling and/or DCI format 2-0 and/or DCI format 1_0 and/or DCI format 1_1 and/or DCI format 0_1 and/or DCI format 0_0 and/or DCI format 0_1 and/or DCI format 2_3 and/or a RAR UL grant and/or fallbackRAR UL grant and/or successRAR.

In some embodiments, the terminal device 110-1 may determine whether a slot (for example, a slot starting from slot n or a slot no earlier than slot n or a slot later than slot n) is valid based on the slot configuration which is configured in the RRC with tdd-UL-DL-ConfigurationCommon and/or tdd-UL-DL-ConfigDedicated. For example, regardless of dynamic scheduling and/or DCI format 2-0 and/or DCI format 1_0 and/or DCI format 1_1 and/or DCI format 0_1 and/or DCI format 0_0 and/or DCI format 0_1 and/or DCI format 2_3 and/or a RAR UL grant and/or fallbackRAR UL grant and/or successRAR.

In some embodiments, if any one of the symbols for all the SRS resource(s) in the SRS resource set is flexible and/or uplink which is defined by tdd-UL-DL-ConfigurationCommon and/or tdd-UL-DL-ConfigDedicated, the slot for transmitting may be regarded as valid or counted in the offset. In some embodiments, if at least one of the symbols for all the SRS resource(s) in the SRS resource set is downlink and/or flexible which is defined by tdd-UL-DL-ConfigurationCommon and/or tdd-UL-DL-ConfigDedicated, the slot for transmitting may regarded as invalid or not valid or not counted in the offset.

In some embodiments, for a slot (for example, a slot starting from slot n or a slot no earlier than slot n or a slot later than slot n), if any one of the symbols for all the SRS resource(s) in the SRS resource set is flexible and/or uplink (for example, which is defined by tdd-UL-DL-ConfigurationCommon and/or tdd-UL-DL-ConfigDedicated), the slot may be regarded as valid or counted in the offset. In some embodiments, for a slot (for example, a slot starting from slot n or a slot no earlier than slot n or a slot later than slot n), if at least one of the symbols for all the SRS resource(s) in the SRS resource set is downlink and/or flexible (for example, which is defined by tdd-UL-DL-ConfigurationCommon and/or tdd-UL-DL-ConfigDedicated), the slot may regarded as invalid or not valid or not counted in the offset.

In some embodiments, the terminal device 110-1 may determine a slot for aperiodic SRS transmission. For example, if the indication is received at the slot n and the slot offset is configured as k, the slot for aperiodic SRS transmission may be any one of: the slot n+k, the first valid slot after slot n+k, the second valid slot after slot n+k, the L^{th} available slot after slot n+k, the k^{th} available slot, the (k+l)^{th} available slot or the (k+i)^{th} available slot, where the parameter “i” may be any suitable positive integer and the parameter “L” may be any suitable positive integer. In some embodiments, i is non-negative integer. For example, the value of “i” may be from 0 to 10. Alternatively, the value of “i” may be from 0 to 32. In some embodiments, L is non-negative integer. For example, the value of “L” may be from 0 to 32. Alternatively, the value of “L” may be from 0 to 10. In some embodiments, the value of L may be predetermined. In some embodiments, the value of L may be configured by the network device 120 via at least one of RRC signaling, MAC CE and DCI. In some embodiments, the value of L may be different for different value of k. For example, for a value k1 of k, the value of L is L1. And for a value k2 of k, the value of L is L2. And if k1>k2, then L1 should be not smaller than L2. The number of candidate slots can be any suitable number. In some embodiments, whether a slot is valid or not may be determined according to some embodiments in this disclosure. In some embodiments, whether a slot is valid or not may be based on a slot configuration defined according to some embodiments in this disclosure.

In some embodiments, the terminal device 110-1 transmits (e.g. shown as 3030 in FIGS. 3A and 3B) the reference signal to the network device 120 on the slot for transmitting. In some embodiments, the terminal device 110-1 may transmit the reference signal on the slot based on the indicated timing related to a slot n, wherein the RS triggering slot is represented as the slot n. Alternatively, the terminal device 110-1 may transmit the reference signal on the slot based on the indicated timing related to a slot (n+k), wherein the RS triggering slot is represents as the slot n and the value of slot offset is represented k. In other embodiments, the terminal device 110-1 may transmit the reference signal on the slot based on the indicated timing which is the RS triggering slot satisfying a timing requirement between the last symbol for transmitting the indication and the first symbol of a resource for transmitting the reference signal.

In other embodiments, the reference signal may be transmitted on the slot based on the indicated timing related to a slot prior to the RS triggering slot. Alternatively, the reference signal may be transmitted n the slot based on the indicated timing related to a starting slot of a slot period prior to the RS triggering slot.

In some embodiments, the slot for transmitting the reference signal may be at least one of: the slot is the (k+i)^{th} valid slot starting from the RS triggering slot, wherein i is non-negative integer, the slot is the L^{th} valid slot starting from a slot (n+k), wherein the RS triggering slot is represents as the slot n and the value of slot offset is represented k wherein L is non negative integer, the slot is the p^{th} or the (p+l)^{th} valid slot starting from slot (n+q), wherein the RS triggering slot is represented as the slot n, the parameter “p” is a non-negative integer number, the parameter “q” is a non-negative integer number, and the sum of p and q matches with a slot offset k, or the slot is the (Y+1+n mod Z)^{th} or the (Y+n mod Z)^{th} valid slot, wherein the RS triggering slot is represented as the slot n, the parameter “Y” is a non-negative integer number and the parameter “Z” is a positive integer number. In some embodiments, the values of “p” and “q” are different for different values of the slot offset “k”, or the value of “q” or “p” are a value of floor (k/2); the value of “Y” is a value of a slot offset “k” or the value of “Y” is a value of floor (k/2).

In another embodiment, the reference signal may be transmitted on the slot (n+k) wherein the slot (n+k) is valid. Alternatively, the reference signal may be transmitted on a valid slot wherein the slot(n+k) is not valid. In this situation, the RS triggering slot is represents as the slot n and the value of slot offset is represented k.

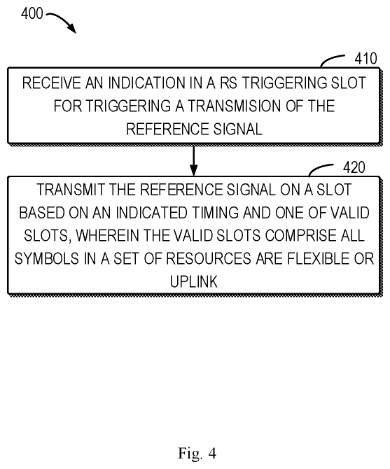

FIG. 4 shows a flowchart of an example method 400 in accordance with an embodiment of the present disclosure. Only for the purpose of illustrations, the method 400 can be implemented at a terminal device 110-1 as shown in FIG. 1.

In some embodiments, the terminal device 110-1 may receive information from the network device 120. The information indicates a set of resources for transmitting a reference signal. In some embodiments, the RS may be a downlink RS. For example, the RS may be any one or more of a demodulation reference signal (DMRS), a cell reference signal (CRS), a multicast broadcast single frequency network (MBSFN) reference signal, a positioning reference signal (PRS), a fine time/frequency tracking reference signal (TRS), a phase tracking reference signal (PTRS), a channel state information-reference signal (CSI-RS), a CSI-RS for tracking and a CSI-RS for mobility. In some alternative embodiments, the RS may be an uplink RS. For example, the RS may be any one or more of a sounding reference signal (SRS), a demodulation reference signal (DMRS), a positioning reference signal (PRS), a fine time/frequency tracking reference signal (TRS) and a phase tracking reference signal (PTRS). It should be noted that the RS may be any downlink or uplink reference signal existing in the art or to be developed in the future.

In some embodiments, the information may comprise a slot offset value of the set of resources. In some embodiments where multiple resource sets are configured, the information may comprise a set of slot offset values (also referred to as a first set of slot offset values below) for the multiple resource sets. For example, the values of slot offset in the set are different to each other. In some embodiments, the first set of slot offset values may comprise a slot offset value for each of the multiple resource sets. In some embodiments, the number of slot offset values in the first set of slot offset values may be smaller than the number of the multiple resource sets. In some embodiments, the network device 110 may configure the first information to the terminal device 120 in a radio resource control (RRC) message. It should be note that the first information may be transmitted in any other suitable ways, for example, in a media access control (MAC) control element (CE) or downlink control information (DCI), and the present disclosure does not make limitation for this.

In some embodiments, the network device and the terminal device may communicate with each other based on time slots (or slots for short) as defined in the 3GPP specifications. For example, for subcarrier spacing configuration μ, slots are numbered nₛ^{μ}ϵ{0, . . . , Nₛₗₒₜ^{subframe,μ}−1} in an increasing order within a subframe and n_{s,f}^{μ}ϵ {0, . . . , Nₛₗₒₜ^{frame,μ}−1} in an increasing order within a frame. There are N_{symb}^{slot} consecutive Orthogonal Frequency Division Multiplexing (OFDM) symbols in a slot where N_{symb}^{slot} depends on the cyclic prefix as given in related 3GPP specifications (TS 38.211), as shown in Table 1 and Table 2. The start of slot nₛ^{μ} in a subframe is aligned in time with the start of OFDM symbol Nₛ^{μ}N_{symb}^{slot} in the same subframe. Other related definitions and information of slots can be found in existing or future 3GPP specifications. More generally, the term slot as used herein can refer to any existing defined unit of time or any unit of time to be defined in the future.

At block 410, the terminal device 110-1 receives an indication from the network device 120 in a RS triggering slot. The indication is to trigger transmitting the reference signal. In some embodiments, the indication may be transmitted or received at slot n. In some embodiments, n is non-negative integer. For example, the value of “n” may be from 0 to 150. For example, the indication may be transmitted in DCI and/or MAC CE. In some embodiments, the network device 120 may configure a slot offset k to the terminal device 110. In some embodiments, k is non-negative integer. For example, the value of “k” may be from 0 to 32. Alternatively, the value of “k” may be from 0 to 64.

In some embodiments, the terminal device 110-1 may determine a slot for transmitting for transmitting the reference signal based on an indicated timing and one of valid slots. The valid slots comprise all symbols in a set of resources are flexible or uplink. In some embodiments, the terminal device 110-1 may determine a plurality of candidate slots for aperiodic SRS transmission.

For example, if the indication is received at the slot n and the slot offset is k, the plurality of candidate slots may comprise one or more of: the slot n+k, the first valid slot after slot n+k, the second valid slot after slot n+k, the L^{th} available slot after slot n+k, the k^{th} available slot, the (k+l)^{th} available slot or the (k+i)^{th} available slot, where the parameter “i” may be any suitable positive integer and the parameter “L” may be any suitable positive integer. In some embodiments, i is non-negative integer. For example, the value of “i” may be from 0 to 10. Alternatively, the value of “i” may be from 0 to 32. In some embodiments, L is non-negative integer. For example, the value of “L” may be from 0 to 32. Alternatively, the value of “L” may be from 0 to 10. In some embodiments, the value of L may be predetermined. In some embodiments, the value of L may be configured by the network device 120 via at least one of RRC signaling, MAC CE and DCI. In some embodiments, the value of L may be different for different value of k. For example, for a value k1 of k, the value of L is L1. And for a value k2 of k, the value of L is L2. And if k1>k2, then L1 should be not smaller than L2. The number of candidate slots can be any suitable number. In some embodiments, the number of candidate slots may be predetermined. Alternatively or in addition, the number of the candidate slots may be configured by the network device 120 via at least one of RRC signaling, MAC CE and DCI. For example, the number of the candidate slots may be configured by RRC signaling. Alternatively, the MAC CE may be used to configure the number of the candidate slots. In another embodiment, the DCI may indicate the number of the candidate slots.

In some embodiments, a resource or a candidate slot may be regarded as available if there are available uplink symbol(s) and/or flexible symbol(s) for the configured time-domain location(s) in the resource or in the slot for all the RS resources in the resource set and/or if the resource or the slot satisfies the minimum timing requirement between the triggering indication and all the RS resources in the resource set.

In some embodiments, the terminal device 110-1 determines a slot for transmitting for transmitting the reference signal. In some embodiments, the slot for transmitting may be at least one of the slot n+k, the first valid slot after slot n+k, the second valid slot after slot n+k, the L^{th} available slot after slot n+k, the k^{th} available slot, the (k+l)^{th} available slot or the (k+i)^{th} available slot. In some embodiments, the number of slots between the RS triggering slot and the slot for transmitting may be within a predetermined range. For example, if the indication is received at the slot n (i.e., the RS triggering slot may be represented as slot n), the slot for transmitting may be no later than the slot n+M, wherein

M is any positive integer number. Alternatively, the slot for transmitting may be earlier than the slot n+M. For example, M may be any number from 1 to 64. Alternatively, M may be any number from 1 to 32. In some embodiments, the value of M may be predetermined. Alternatively or in addition, the value of M may be configured by the network device 120 via at least one of RRC signaling, MAC CE and DCI. For example, the value of M may be configured by RRC signaling. Alternatively, the MAC CE may be used to configure the value of M. In another embodiment, the DCI may indicate the value of M. In some embodiments, if the slot for transmitting is later than the slot n+M, the terminal device may not transmit the configured/triggered RS.

In some embodiments, the terminal device 110-1 may determine a slot (referred to as “a seventh slot” hereinafter) based on the RS triggering slot and a slot offset. In some embodiments, the slot for transmitting may be determined based on the seventh slot and a second predetermined number of slots. The number of slots between the slot for transmitting and the seventh slot may be below or smaller than or no larger than the second predetermined number. The second predetermined number may be any suitable integer. For example, if the indication is received at the slot n (i.e., the RS triggering slot may be represented as slot n), the interval between the slot for transmitting and the slot n+k (i.e., the seventh slot) may be less than or no larger than X slots, where X may be a non-negative integer. For example, the X may be from 0 to 32. For another example, the X may be from 0 to 10. In some embodiments, if the interval between the slot for transmitting and the slot n+k (i.e., the seventh slot) is larger than or equal to X slots, the terminal device may not transmit the configured/triggered RS.

In other embodiments, the RS triggering slot, the slot for transmitting and the seventh slot may be in a same slot period. For example, the slot period may be P. For another example, the slot period may be P+P2 . For another example, the slot period may be one frame. For another example, the slot period may be 20 msec, and the first symbol in the 20 msec is the first symbol in an even frame. In some embodiments, if the slot for transmitting and the slot n+k (i.e., the seventh slot) are in different slot period, the terminal device may not transmit the configured/triggered RS. For example, in this way, the SRS transmission offset may not be changed too much.

In some embodiments, the terminal device 110-1 may obtain a first number of slots and a second number of slots. The first number of slots and the second number of slots may be predetermined. Alternatively, the first number of slots and the second number of slots may be configured by the network device 120. The terminal device 110-1 may determine a slot after the second number of slots starting from the RS triggering slot plus the first number of slots to be the slot for transmitting. The sum of the first number of slots and the second number of slots may match a slot offset indicated in the information. For example, if the indication is received in slot n, the slot for transmitting may be the p^{th} or (p+l)^{th} valid slot starting from slot n+q. The values of p and q may be any suitable non-negative integer number. For example, the value of “p” may be from 0 to k. Alternatively, the value of “q” may be from 0 to k. For example, the sum of p and q may be the slot offset k. For another example, the sum of p and q may be k+1. For another example, the sum of p and q may be k−1. In some embodiments, the value of p and/or the value of q may be different based on different values of the slot offset k. In some embodiments, the value of p and/or the value of q may be predetermined. In some embodiments, the value of p and/or the value of q may be configured by the network device via at least one of RRC, MAC CE and DCI. In some embodiments, p may be floor (k/2) and q may be [k-floor(k/2)]. For example, in this way, the SRS transmission offset may not be changed too much.

In other embodiments, the terminal device 110-1 may obtain a third number of slots and a fourth number of slots. The third number of slots and the fourth number of slots may be predetermined. Alternatively, the third number of slots and the fourth number of slots may be configured by the network device 120. For example, if the indication is received in slot n and the slot offset is k, the slot for transmitting may be (Y+1+n mod Z)^{th} available slot or (Y+n mod Z)^{th} available slot. The value of Y may be the value of slot offset k. Alternatively, the value of Y may be the value of p. Alternatively, the value of Y may be the value of q. In some embodiments, the value of Z may be predetermined. In some embodiments, the value of Z may be configured by the network device via at least one of RRC, MAC CE and DCI. In some embodiments, the value of Z can be any positive integer number. For example, the value of Z may be from 2 to 10. For example, in this way, the congestion for SRS transmission can be avoided.

In some embodiments, the terminal device 110-1 may select the slot for transmitting from the plurality of candidate slots. For example, the slot for transmitting may be determined based on priorities of the plurality of candidate slots. In some embodiments, as mentioned above, the terminal device 110-1 may determine (e.g. 3015) a plurality of candidate slots for aperiodic SRS transmission. For example, if the indication is received at the slot n and the slot offset is k, the plurality of candidate slots may comprise one or more of: the slot n+k, the first valid slot after slot n+k, the second valid slot after slot n+k, the L^{th} available slot after slot n+k, the kth available slot, the (k+1)^{th} available slot or the (k+i)^{th} available slot, where the parameter “i” may be any suitable positive integer and the parameter “L” may be any suitable positive integer. In some embodiments, i is non-negative integer. For example, the value of “i” may be from 0 to 10. Alternatively, the value of “i” may be from 0 to 32. In some embodiments, L is non-negative integer. For example, the value of “L” may be from 0 to 32. Alternatively, the value of “L” may be from 0 to 10. Only as an example, the priority of the slot n+k is higher than the priority of the k^{th} available slot. For another example, the priority of the k^{th} available slot is higher than the (k+1)^{th} available slot. For example, if the slot n+k is valid, the terminal device 110-1 may select the slot n+k to be the slot for transmitting. If the slot n+k is not valid, the terminal device 110-1 may select the first valid slot after slot n+k or the second valid slot after slot n+k or the Lth available slot after slot n+k or the k^{th} available slot, the (k+l)^{th} available slot or the (k+i)^{th} available slot to be the slot for transmitting.

At block 420, the terminal device 110-1 transmits the reference signal to the network device 120 on the slot for transmitting which is determined based on an indicated timing and one of valid slots, wherein the valid slots comprise all symbols in a set of resources are flexible or uplink. In some embodiments, the indicated timing may the RS triggering slot. Alternatively, the indicated timing may be the RS trigger slot plus the slot offset.

In some embodiments, the terminal device 110-1 determines whether the slot for transmitting is valid based on a slot configuration. In some embodiments, the terminal device 110-1 may determine whether the slot for transmitting is valid based on the slot configuration related to the RS triggering slot. In other words, if the indication is received in the slot n, the slot for transmitting may be determined to be valid or not based on the slot configuration related to the slot n. In some embodiments, the terminal device 110-1 may determine whether a slot (for example, a slot starting from slot n or a slot no earlier than slot n or a slot starting from slot n+k or a slot no earlier than slot n+k) is valid or not based on the latest slot configuration which is configured or determined or defined no later than slot n. In some embodiments, the terminal device 110-1 may determine a slot (for example, a slot starting from slot n or a slot no earlier than slot n or a slot starting from slot n+k or a slot no earlier than slot n+k) is valid or not based on the slot configuration which is configured or determined or defined in slot n. In some embodiments, the terminal device 110-1 may determine the (valid) slot for transmitting based on the latest slot configuration which is configured or determined or defined no later than slot n. In some embodiments, the terminal device 110-1 may determine the (valid) slot for transmitting based on the slot configuration which is configured or determined or defined in slot n.

Alternatively, the terminal device 110-1 may determine whether the slot for transmitting is valid based on the slot configuration related to the RS triggering slot and a slot offset. For example, if the indication is received in the slot n and the slot offset is k, the slot for transmitting may be determined to be valid based on the slot configuration defined in the slot n+k. In some embodiments, the terminal device 110-1 may determine whether a slot (for example, a slot starting from slot n or a slot no earlier than slot n or a slot starting from slot n+k or a slot no earlier than slot n+k) is valid or not based on the latest slot configuration which is configured or determined or defined no later than slot n+k. In some embodiments, the terminal device 110-1 may determine a slot (for example, a slot starting from slot n or a slot no earlier than slot n or a slot starting from slot n+k or a slot no earlier than slot n+k) is valid or not based on the slot configuration which is configured or determined or defined in slot n+k. In some embodiments, the terminal device 110-1 may determine the (valid) slot for transmitting based on the latest slot configuration which is configured or determined or defined no later than slot n+k. In some embodiments, the terminal device 110-1 may determine the (valid) slot for transmitting based on the slot configuration which is configured or determined or defined in slot n+k.

In some embodiments, for the slot(s) starting from slot n to slot n+k or the slot(s) which are no earlier than slot n and no later than slot n+k or the slot(s) which are no earlier than slot n and earlier than slot n+k, the terminal device 110-1 may determine whether the slot(s) is valid or not based on the latest slot configuration which is configured or determined or defined no later than slot n. In some embodiments, for the slot(s) starting from slot n to slot n+k or the slot(s) which are no earlier than slot n and no later than slot n+k or the slot(s) which are no earlier than slot n and earlier than slot n+k, the terminal device 110-1 may determine whether the slot(s) is valid or not based on the latest slot configuration which is configured or determined or defined in slot n. In some embodiments, for the slot(s) starting from slot n+k or the slot(s) which are no earlier than slot n+k or the slot(s) which are later than slot n+k, the terminal device 110-1 may determine whether the slot(s) is valid or not based on the latest slot configuration which is configured or determined or defined no later than slot n+k. In some embodiments, for the slot(s) starting from slot n+k or the slot(s) which are no earlier than slot n+k or the slot(s) which are later than slot n+k, the terminal device 110-1 may determine whether the slot(s) is valid or not based on the latest slot configuration which is configured or determined or defined in slot n+k.

In other embodiments, the terminal device 110-1 may determine whether the slot for transmitting is valid based on the slot configuration related to a third slot. The third slot may satisfy a timing requirement between the last symbol for transmitting the indication and the first symbol of a resource for transmitting the reference signal in the set of resources. For example, the third slot may be a RS triggering slot satisfying the minimum timing requirement between triggering PDCCH and all the SRS resources in the resource set. For example, the minimal time interval between the last symbol of the PDCCH triggering the aperiodic SRS transmission and the first symbol of SRS resource is X symbols (for example, X=N2+14+Tswitch or X=N2+Tswitch), whether the slot is valid or not is based on the slot configuration related to the slot n+ceil(X/14) or the slot min(n+k, n+ceil(x/14)). In some embodiments, the terminal device 110-1 may determine whether a slot (for example, a slot starting from slot n or a slot no earlier than slot n or a slot starting from slot n+k or a slot no earlier than slot n+k or a slot no earlier than the third slot or a slot starting from the third slot or a slot later than the third slot) is valid or not based on the latest slot configuration which is configured or determined or defined no later than the third slot. In some embodiments, the terminal device 110-1 may determine a slot (for example, a slot starting from slot n or a slot no earlier than slot n or a slot starting from slot n+k or a slot no earlier than slot n+k or a slot no earlier than the third slot or a slot starting from the third slot or a slot later than the third slot) is valid or not based on the slot configuration which is configured or determined or defined in the third slot. In some embodiments, the terminal device 110-1 may determine the (valid) slot for transmitting based on the latest slot configuration which is configured or determined or defined no later than the third slot. In some embodiments, the terminal device 110-1 may determine the (valid) slot for transmitting based on the slot configuration which is configured or determined or defined in the third slot.

In some embodiments, for the slot(s) starting from slot n to the third slot or the slot(s) which are no earlier than slot n and no later than the third slot or the slot(s) which are no earlier than slot n and earlier than the third slot, the terminal device 110-1 may determine whether the slot(s) is valid or not based on the latest slot configuration which is configured or determined or defined no later than slot n. In some embodiments, for the slot(s) starting from slot n to the third slot or the slot(s) which are no earlier than slot n and no later than the third slot or the slot(s) which are no earlier than slot n and earlier than the third slot, the terminal device 110-1 may determine whether the slot(s) is valid or not based on the latest slot configuration which is configured or determined or defined in slot n. In some embodiments, for the slot(s) starting from the third slot or the slot(s) which are no earlier than the third slot or the slot(s) which are later than the third slot, the terminal device 110-1 may determine whether the slot(s) is valid or not based on the latest slot configuration which is configured or determined or defined no later than the third slot. In some embodiments, for the slot(s) starting from the third slot or the slot(s) which are no earlier than the third slot or the slot(s) which are later than the third slot, the terminal device 110-1 may determine whether the slot(s) is valid or not based on the latest slot configuration which is configured or determined or defined in the third slot.

In some embodiments, the network device 120 may transmit further information indicating a fourth slot. The further information may be transmitted via RRC signaling. Alternatively, the further information may be transmitted in MAC CE. In other embodiments, the further information may be transmitted in DCI. The terminal device 110-1 may determine whether the slot for transmitting is valid based on the slot configuration related to the fourth slot. In some embodiments, the terminal device 110-1 may determine whether a slot (for example, a slot starting from slot n or a slot no earlier than slot n or a slot starting from slot n+k or a slot no earlier than slot n+k or a slot no earlier than the fourth slot or a slot starting from the fourth slot or a slot later than the fourth slot) is valid or not based on the latest slot configuration which is configured or determined or defined no later than the fourth slot. In some embodiments, the terminal device 110-1 may determine a slot (for example, a slot starting from slot n or a slot no earlier than slot n or a slot starting from slot n+k or a slot no earlier than slot n+k or a slot no earlier than the fourth slot or a slot starting from the fourth slot or a slot later than the fourth slot) is valid or not based on the slot configuration which is configured or determined or defined in the fourth slot. In some embodiments, the terminal device 110-1 may determine the (valid) slot for transmitting based on the latest slot configuration which is configured or determined or defined no later than the fourth slot. In some embodiments, the terminal device 110-1 may determine the (valid) slot for transmitting based on the slot configuration which is configured or determined or defined in the fourth slot.

In some embodiments, for the slot(s) starting from slot n to the fourth slot or the slot(s) which are no earlier than slot n and no later than the fourth slot or the slot(s) which are no earlier than slot n and earlier than the fourth slot, the terminal device 110-1 may determine whether the slot(s) is valid or not based on the latest slot configuration which is configured or determined or defined no later than slot n. In some embodiments, for the slot(s) starting from slot n to the fourth slot or the slot(s) which are no earlier than slot n and no later than the fourth slot or the slot(s) which are no earlier than slot n and earlier than the fourth slot, the terminal device 110-1 may determine whether the slot(s) is valid or not based on the latest slot configuration which is configured or determined or defined in slot n. In some embodiments, for the slot(s) starting from the fourth slot or the slot(s) which are no earlier than the fourth slot or the slot(s) which are later than the fourth slot, the terminal device 110-1 may determine whether the slot(s) is valid or not based on the latest slot configuration which is configured or determined or defined no later than the fourth slot. In some embodiments, for the slot(s) starting from the fourth slot or the slot(s) which are no earlier than the fourth slot or the slot(s) which are later than the fourth slot, the terminal device 110-1 may determine whether the slot(s) is valid or not based on the latest slot configuration which is configured or determined or defined in the fourth slot.

In a yet embodiment, the terminal device 110-1 may determine whether the slot for transmitting is valid based on the slot configuration related to a fifth slot which is a slot prior to the RS triggering slot. For example, the fifth slot may be the latest slot with detected DCI format 2-0 which is earlier or no later than the RS triggering slot (i.e., the slot n). In some embodiments, the terminal device 110-1 may determine whether a slot (for example, a slot starting from slot n or a slot no earlier than slot n or a slot starting from slot n+k or a slot no earlier than slot n+k or a slot no earlier than the fifth slot or a slot starting from the fifth slot or a slot later than the fifth slot) is valid or not based on the latest slot configuration which is configured or determined or defined no later than the fifth slot. In some embodiments, the terminal device 110-1 may determine a slot (for example, a slot starting from slot n or a slot no earlier than slot n or a slot starting from slot n+k or a slot no earlier than slot n+k or a slot no earlier than the fifth slot or a slot starting from the fifth slot or a slot later than the fifth slot) is valid or not based on the slot configuration which is configured or determined or defined in the fifth slot. In some embodiments, the terminal device 110-1 may determine the (valid) slot for transmitting based on the latest slot configuration which is configured or determined or defined no later than the fifth slot. In some embodiments, the terminal device 110-1 may determine the (valid) slot for transmitting based on the slot configuration which is configured or determined or defined in the fifth slot.

In some embodiments, for the slot(s) starting from slot n to the fifth slot or the slot(s) which are no earlier than slot n and no later than the fifth slot or the slot(s) which are no earlier than slot n and earlier than the fifth slot, the terminal device 110-1 may determine whether the slot(s) is valid or not based on the latest slot configuration which is configured or determined or defined no later than slot n. In some embodiments, for the slot(s) starting from slot n to the fifth slot or the slot(s) which are no earlier than slot n and no later than the fifth slot or the slot(s) which are no earlier than slot n and earlier than the fifth slot, the terminal device 110-1 may determine whether the slot(s) is valid or not based on the latest slot configuration which is configured or determined or defined in slot n. In some embodiments, for the slot(s) starting from the fifth slot or the slot(s) which are no earlier than the fifth slot or the slot(s) which are later than the fifth slot, the terminal device 110-1 may determine whether the slot(s) is valid or not based on the latest slot configuration which is configured or determined or defined no later than the fifth slot. In some embodiments, for the slot(s) starting from the fifth slot or the slot(s) which are no earlier than the fifth slot or the slot(s) which are later than the fifth slot, the terminal device 110-1 may determine whether the slot(s) is valid or not based on the latest slot configuration which is configured or determined or defined in the fifth slot.

In other embodiments, the terminal device 110-1 may determine whether the slot for transmitting is valid based on the slot configuration related to a sixth slot which is a starting slot of a slot period prior to the RS triggering slot. For example, the sixth slot may be the starting slot of the latest slot format periodicity which is earlier or no later than the RS triggering slot (i.e., the slot n). In some embodiments, the terminal device 110-1 may determine whether a slot (for example, a slot starting from slot n or a slot no earlier than slot n or a slot starting from slot n+k or a slot no earlier than slot n+k or a slot no earlier than the sixth slot or a slot starting from the sixth slot or a slot later than the sixth slot) is valid or not based on the latest slot configuration which is configured or determined or defined no later than the sixth slot. In some embodiments, the terminal device 110-1 may determine a slot (for example, a slot starting from slot n or a slot no earlier than slot n or a slot starting from slot n+k or a slot no earlier than slot n+k or a slot no earlier than the sixth slot or a slot starting from the sixth slot or a slot later than the sixth slot) is valid or not based on the slot configuration which is configured or determined or defined in the sixth slot. In some embodiments, the terminal device 110-1 may determine the (valid) slot for transmitting based on the latest slot configuration which is configured or determined or defined no later than the sixth slot. In some embodiments, the terminal device 110-1 may determine the (valid) slot for transmitting based on the slot configuration which is configured or determined or defined in the sixth slot.

In some embodiments, for the slot(s) starting from slot n to the sixth slot or the slot(s) which are no earlier than slot n and no later than the sixth slot or the slot(s) which are no earlier than slot n and earlier than the sixth slot, the terminal device 110-1 may determine whether the slot(s) is valid or not based on the latest slot configuration which is configured or determined or defined no later than slot n. In some embodiments, for the slot(s) starting from slot n to the sixth slot or the slot(s) which are no earlier than slot n and no later than the sixth slot or the slot(s) which are no earlier than slot n and earlier than the sixth slot, the terminal device 110-1 may determine whether the slot(s) is valid or not based on the latest slot configuration which is configured or determined or defined in slot n. In some embodiments, for the slot(s) starting from the sixth slot or the slot(s) which are no earlier than the sixth slot or the slot(s) which are later than the sixth slot, the terminal device 110-1 may determine whether the slot(s) is valid or not based on the latest slot configuration which is configured or determined or defined no later than the sixth slot. In some embodiments, for the slot(s) starting from the sixth slot or the slot(s) which are no earlier than the sixth slot or the slot(s) which are later than the sixth slot, the terminal device 110-1 may determine whether the slot(s) is valid or not based on the latest slot configuration which is configured or determined or defined in the sixth slot.

In some embodiments, the terminal device 110-1 may determine whether the slot for transmitting is valid only based on the slot configuration. For example, the terminal device 110-1 may determine whether the slot for transmitting is valid based on the RRC configured slot configuration tdd-UL-DL-ConfigurationCommon and/or tdd-UL-DL-ConfigDedicated. For example, regardless of dynamic scheduling and/or DCI format 2-0 and/or DCI format 1_0 and/or DCI format 1_1 and/or DCI format 0_1 and/or DCI format 0_0 and/or DCI format 0_1 and/or DCI format 2_3 and/or a RAR UL grant and/or fallbackRAR UL grant and/or successRAR.

In some embodiments, the terminal device 110-1 may determine whether a slot (for example, a slot starting from slot n or a slot no earlier than slot n or a slot later than slot n) is valid based on the slot configuration which is configured in the RRC with tdd-UL-DL-ConfigurationCommon and/or tdd-UL-DL-ConfigDedicated. For example, regardless of dynamic scheduling and/or DCI format 2-0 and/or DCI format 1_0 and/or DCI format 1_1 and/or DCI format 0_1 and/or DCI format 0_0 and/or DCI format 0_1 and/or DCI format 2_3 and/or a RAR UL grant and/or fallbackRAR UL grant and/or successRAR.

In some embodiments, if any one of the symbols for all the SRS resource(s) in the SRS resource set is flexible and/or uplink which is defined by tdd-UL-DL-ConfigurationCommon and/or tdd-UL-DL-ConfigDedicated, the slot for transmitting may be regarded as valid or counted in the offset. In some embodiments, if at least one of the symbols for all the SRS resource(s) in the SRS resource set is downlink and/or flexible which is defined by tdd-UL-DL-ConfigurationCommon and/or tdd-UL-DL-ConfigDedicated, the slot for transmitting may regarded as invalid or not valid or not counted in the offset.

In some embodiments, if any one of the symbols for all the SRS resource(s) in the SRS resource set is flexible and/or uplink which is defined by tdd-UL-DL-ConfigurationCommon and/or tdd-UL-DL-ConfigDedicated, the slot (for example, a slot starting from slot n or a slot no earlier than slot n or a slot later than slot n) may be regarded as valid or counted in the offset. In some embodiments, if at least one of the symbols for all the SRS resource(s) in the SRS resource set is downlink and/or flexible which is defined by tdd-UL-DL-ConfigurationCommon and/or tdd-UL-DL-ConfigDedicated, the slot (for example, a slot starting from slot n or a slot no earlier than slot n or a slot later than slot n) may regarded as invalid or not valid or not counted in the offset.

In some embodiments, the terminal device 110-1 may transmit the reference signal on the slot based on the indicated timing related to a slot n, wherein the RS triggering slot is represented as the slot n. Alternatively, the terminal device 110-1 may transmit the reference signal on the slot based on the indicated timing related to a slot (n+k), wherein the RS triggering slot is represents as the slot n and the value of slot offset is represented k. In other embodiments, the terminal device 110-1 may transmit the reference signal on the slot based on the indicated timing which is the RS triggering slot satisfying a timing requirement between the last symbol for transmitting the indication and the first symbol of a resource for transmitting the reference signal.

In other embodiments, the reference signal may be transmitted on the slot based on the indicated timing related to a slot prior to the RS triggering slot. Alternatively, the reference signal may be transmitted n the slot based on the indicated timing related to a starting slot of a slot period prior to the RS triggering slot.

In some embodiments, the slot for transmitting the reference signal may be at least one of: the slot is the (k+i)^{th} valid slot starting from the RS triggering slot, wherein i is non-negative integer, the slot is the L^{th} valid slot starting from a slot (n+k), wherein the RS triggering slot is represents as the slot n and the value of slot offset is represented k wherein L is non negative integer, the slot is the p^{th} or the (p+l)^{th} valid slot starting from slot (n+q), wherein the RS triggering slot is represented as the slot n, the parameter “p” is a non-negative integer number, the parameter “q” is a non-negative integer number, and the sum of p and q matches with a slot offset k, or the slot is the (Y+l+n mod Z)^{th} or the (Y+n mod Z)^{th} valid slot, wherein the RS triggering slot is represented as the slot n, the parameter “Y” is a non-negative integer number and the parameter “Z” is a positive integer number. In some embodiments, the values of “p” and “q” are different for different values of the slot offset “k”, or the value of “q” or “p” are a value of floor (k/2); the value of “Y” is a value of a slot offset “k” or the value of “Y” is a value of floor (k/2).

In another embodiment, the reference signal may be transmitted on the slot (n+k) wherein the slot (n+k) is valid. Alternatively, the reference signal may be transmitted on a valid slot wherein the slot(n+k) is not valid. In this situation, the RS triggering slot is represents as the slot n and the value of slot offset is represented k.

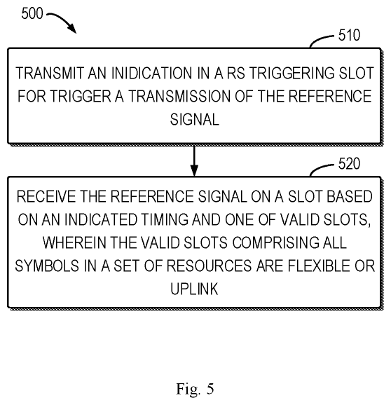

FIG. 5 shows a flowchart of an example method 500 in accordance with an embodiment of the present disclosure. Only for the purpose of illustrations, the method 500 can be implemented at a network device 120 as shown in FIG. 1.

In some embodiments, the network device 120 may transmit information to the terminal device 110-1. The information indicates a set of resources for transmitting a reference signal. In some embodiments, the RS may be a downlink RS. For example, the RS may be any one or more of a demodulation reference signal (DMRS), a cell reference signal (CRS), a multicast broadcast single frequency network (MBSFN) reference signal, a positioning reference signal (PRS), a fine time/frequency tracking reference signal (TRS), a phase tracking reference signal (PTRS), a channel state information-reference signal (CSI-RS), a CSI-RS for tracking and a CSI-RS for mobility. In some alternative embodiments, the RS may be an uplink RS. For example, the RS may be any one or more of a sounding reference signal (SRS), a demodulation reference signal (DMRS), a positioning reference signal (PRS), a fine time/frequency tracking reference signal (TRS) and a phase tracking reference signal (PTRS). It should be noted that the RS may be any downlink or uplink reference signal existing in the art or to be developed in the future.

In some embodiments, the information may comprise a slot offset value of the set of resources. In some embodiments where multiple resource sets are configured, the information may comprise a set of slot offset values (also referred to as a first set of slot offset values below) for the multiple resource sets. For example, the values of slot offset in the set are different to each other. In some embodiments, the first set of slot offset values may comprise a slot offset value for each of the multiple resource sets. In some embodiments, the number of slot offset values in the first set of slot offset values may be smaller than the number of the multiple resource sets. In some embodiments, the network device 110 may configure the first information to the terminal device 120 in a radio resource control (RRC) message. It should be note that the first information may be transmitted in any other suitable ways, for example, in a media access control (MAC) control element (CE) or downlink control information (DCI), and the present disclosure does not make limitation for this.

In some embodiments, the network device and the terminal device may communicate with each other based on time slots (or slots for short) as defined in the 3GPP specifications. For example, for subcarrier spacing configuration μ, slots are numbered nₛ^{μ}ϵ {0, . . . , Nₛₗₒₜ^{subframe,μ}−1} in an increasing order within a subframe and n_{s,f}^{μ}ϵ {0, . . . , Nₛₗₒₜ^{frame,μ}−1} in an increasing order within a frame. There are N_{symb}^{slot} consecutive Orthogonal Frequency Division Multiplexing (OFDM) symbols in a slot where N_{symb}^{slot} depends on the cyclic prefix as given in related 3GPP specifications (TS 38.211), as shown in Table 1 and Table 2. The start of slot nₛ^{μ} in a subframe is aligned in time with the start of OFDM symbol nₛ^{μ}N_{symb}^{slot} in the same subframe. Other related definitions and information of slots can be found in existing or future 3GPP specifications. More generally, the term slot as used herein can refer to any existing defined unit of time or any unit of time to be defined in the future.

At block 510, the network device 120 transmits an indication in a reference signal (RS) triggering slot for triggering a transmission of the reference signal. The indication is to trigger transmitting the reference signal. In some embodiments, the indication may be transmitted or received at slot n. In some embodiments, n is non-negative integer. For example, the value of “n” may be from 0 to 150. For example, the indication may be transmitted in DCI and/or MAC CE. In some embodiments, the network device 120 may configure a slot offset k to the terminal device 110. In some embodiments, k is non-negative integer. For example, the value of “k” may be from 0 to 32. Alternatively, the value of “k” may be from 0 to 64.

In some embodiments, the network device 120 may transmit further information indicating a fourth slot. The further information may be transmitted via RRC signaling. Alternatively, the further information may be transmitted in MAC CE. In other embodiments, the further information may be transmitted in DCI. The terminal device 110-1 may determine whether the slot for transmitting is valid based on the slot configuration related to the fourth slot.

At block 520, the network device 120 receives the reference signal from the first device 110-1 in a slot for transmitting which is determined to be valid based on an indicated timing and a slot offset between the RS triggering slot and the slot for transmitting, the slot offset indicting the number of flexible slots and/or uplink slots between the RS triggering slot and the slot for transmitting.

In some embodiments, the slot for transmitting may be the p^{th} or the (p+l)^{th} available slot starting from slot (n+q), wherein slot n represents the slot on which the RS triggering indication is received, the parameter “p” is a non-negative integer number, the parameter “q” is a non-negative integer number, and the sum of p and q matches with a slot offset k. The network device 120 may transmit further information indicating the values of “p” and “q” and the sum of p and q.

In other embodiments, the slot for transmitting is the (Y+1+n mod Z)^{th} or the (Y+n mod Z)^{th} available slot, wherein slot n represents the slot on which the RS triggering indication is received, the parameter “Y” is a non-negative integer number and the parameter “Z” is a positive integer number. The network device 120 may transmit further information indicating the values of “Y” and “Z”.

In some embodiments, the network device 120 may receive the reference signal on the slot based on the indicated timing related to a slot n, wherein the RS triggering slot is represented as the slot n. Alternatively, the network device 120 may receive the reference signal on the slot based on the indicated timing related to a slot (n+k), wherein the RS triggering slot is represents as the slot n and the value of slot offset is represented k.

In other embodiments, the reference signal may be transmitted on the slot based on the indicated timing which is the RS triggering slot satisfying a timing requirement between the last symbol for transmitting the indication and the first symbol of a resource for receiving the reference signal.

In some embodiments, as mentioned above, the network device 120 may transmit further information indicating a further slot and receive the reference signal on the slot based on the indicated timing related to the further slot.

In a yet embodiment, the network device 120 may receive he reference signal on the slot based on the indicated timing related to a slot prior to the RS triggering slot. Alternatively, the network device 120 may receive the reference signal on the slot based on the indicated timing related to a starting slot of a slot period prior to the RS triggering slot.

In some embodiments, the slot for transmitting may comprise one or more of: the slot is the (k+i)^{th} valid slot starting from the RS triggering slot, wherein i is non negative integer, the slot is the L^{th} valid slot starting from a slot (n+k), wherein the RS triggering slot is represents as the slot n and the value of slot offset is represented k wherein L is non negative integer, the slot is the p^{th} or the (p+l)^{th} valid slot starting from slot (n+q), wherein the RS triggering slot is represented as the slot n, the parameter “p” is a non-negative integer number, the parameter “q” is a non-negative integer number, and the sum of p and q matches with a slot offset k, or the slot is the (Y+1+n mod Z)^{th} or the (Y+n mod Z)^{th} valid slot, wherein the RS triggering slot is represented as the slot n, the parameter “Y” is a non-negative integer number and the parameter “Z” is a positive integer number. The values of “p” and “q” may be different for different values of the slot offset “k”, or the value of “q” or “p” are a value of floor (k/2); the value of “Y” is a value of a slot offset “k” or the value of “Y” is a value of floor (k/2).

In some embodiments, the reference signal may be received on the slot (n+k) wherein the slot (n+k) is valid. Alternatively, the reference signal may be received on a valid slot wherein the slot(n+k) is not valid. The RS triggering slot may be represented as the slot n and the value of slot offset is represented k.

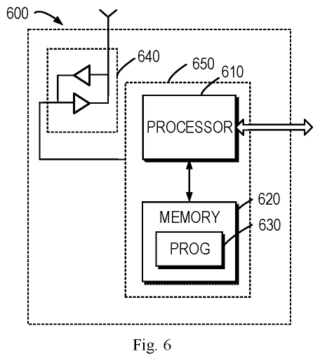

FIG. 6 is a simplified block diagram of a device 600 that is suitable for implementing embodiments of the present disclosure. The device 600 can be considered as a further example implementation of the network device 110 or the terminal device 120 as shown in FIG. 1. Accordingly, the device 600 can be implemented at or as at least a part of the network device 110 or the terminal device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 850 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A method comprising:
receiving an indication in a slot n for triggering a transmission of a reference signal; and
transmitting the reference signal in an available slot, wherein
the available slot is based on a latest determination of a plurality of determinations no later than slot n.

26. The method according to claim 25, wherein
the available slot comprises uplink symbol(s) or flexible symbol(s) for a time-domain location(s) for all RS resources in a resource set; and
the available slot satisfies a minimum timing requirement between triggering PDCCH and all the RS resources in the resource set.

27. The method according to claim 25, wherein
symbol(s) in the available slot is indicated as flexible by tdd-UL-DL-ConfigurationCommon and/or tdd-UL-DL-ConfigDedicated.

28. A terminal comprising a processor configured to:
receiving an indication in a slot n for triggering a transmission of a reference signal; and
transmitting the reference signal in an available slot, wherein
the available slot is based on a latest determination of a plurality of determinations no later than slot n.

29. The terminal according to claim 28, wherein The terminal comprising a processor configured to:
the available slot comprises uplink symbol(s) or flexible symbol(s) for a time-domain location(s) for all RS resources in a resource set; and
the available slot satisfies a minimum timing requirement between triggering PDCCH and all the RS resources in the resource set.

30. The terminal according to claim 28, wherein
symbol(s) in the available slot is indicated as flexible by tdd-UL-DL-ConfigurationCommon and/or tdd-UL-DL-ConfigDedicated.
